(19) United States
(12) Patent Application Publication
(10) Pub. No.: US 2003/0145888 A1
(43) Pub. Date: Aug. 7, 2003

(54) Air bag inflation device

(76) Inventor: Hsiang-Ting Lin, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/060,330

(22) Filed: Feb. 1, 2002

(51) Int. Cl. F16K 15/20

(52) U.S. Cl. 137/223

(57) ABSTRACT

An air bag inflation device comprises a main portion and a check valve; the main portion containing a partition provided with an insertion hole; a U-shaped air ventilation cut surrounding the insertion hole; a positioning bit extending from the opening of the U-shaped cut; a press at between the insertion hole and the ventilation cut opposite to the positioning bit; the check valve having a closing diaphragm, an insertion section provided on one side of the closing diaphragm; the insertion section connected to a caulking section having a conic terminal and in a diameter larger than that of the insertion section; and an extension section connected to the caulking section; the check valve being inserted through the insertion hole in the main portion for the closing diaphragm to cover up the air ventilation port.

### BACKGROUND OF THE INVENTION

(a) Field of the Invention

The present invention relates to an inflation device for an air bag, and more particularly, to one that is used as a padding in a bra cup, an unit in middle sole, a shoulder pad and other air bag structures.

(b) Description of the Prior Art

A conventional air bag inflation device as illustrated in FIG. 1 of the accompany drawings installed in the air bag (not illustrated) comprises a main portion (11), an air inlet valve (12), a pump (13), an air delivery valve (14) and an air release valve (15). Both ends of the main portion (11) are provided with an air inlet chamber (111) and an air delivery chamber (112) with both of said chambers (111, 112) connected through each other. An air pipe (113) is connected to the air inlet chamber (111) on one side and a plate (114) containing an air release chamber (115) extends from the other side. The air inlet valve (12) is a rubber ring having a tab (121) protruding from an inner edge towards the center of the air inlet valve (12). An air check member (122) is provided on the tab (121) and an insertion hole (123) is formed surrounding the tab (121). The air inlet valve (12) is adhered into the air inlet chamber (111). A cover (124) having a central port (125) is separately provided and the opening or closing of the port (125) is controlled by the air check member (122). The pump (13) is a flexible hollow member that can be automatically restored to its original status. A sleeve (131) extends from the pump (13) to connect to the air pipe (113) of the main portion (11). The air delivery valve (14) is a rubber ring having a tab (141) protruding from an inner edge towards the center of the air delivery valve (14). An air check member (142) is provided on the tab (141) and an insertion hole (143) is formed surrounding the tab (141). The air delivery valve (14) is adhered into the air delivery chamber (112). A cover (144) having a tab (145) protruding from an inner edge towards the center of the cover (144) is separately provided. The air check member (142) is used to control the air inside the pump (13) to flow through the air delivery chamber (112). The air release valve (15) is a rubber ring having a tab (151) protruding from an inner edge towards the center of the air release valve (15). An air check member (152) is provided on the tab (151) and an insertion hole (153) is formed surrounding the tab (151). The air release valve (15) is adhered into the air release chamber (115). A cover (154) having a tab (155) protruding from an inner edge towards the center of the cover (154) is separately provided. The air check member (152) is used to control the air to flow through the air release chamber (115).

As illustrated in FIG. 2, the prior art is fixed in an air bag (16). An air inlet port (161) and an air release port (162) are respectively provided in the air bag (16) to respectively connect through and become integrated with the air inlet chamber (111) and the air release chamber (115) of the conventional inflation device. Once the pump (13) is depressed, the check member (122) of the air inlet valve (12) as forced by the air inside the pump (13) blocks out the port (125) in the cover (124). Meanwhile the check member (142) in the air delivery valve (14) is pushed aside to allow the air to forthwith flow into and to inflate the air bag (16). Upon releasing the pump (13), also as illustrated in FIG. 3, the pump (13) creates a suction of negative pressure due to the inherited flexibility of its material to cause the air delivery valve (14) to block out the air delivery chamber (112). Accordingly, the air inlet valve (12) is opened up and the air outside the air bag (16) is allowed to flow through the air inlet port (161) into the air inlet chamber (111) and the air pipe (113). Finally the air flows into the pump (13) until it is restored to its original shape. Meanwhile, the air in the air bag (16) closes up the air delivery chamber (112) and the air release chamber (115). Furthermore, as illustrated in FIG. 4, use a finger to depress the check member (152) of the air release valve (15) to discharge the air in the air bag (16) out of the air release port (162).

However, the prior art as described above has the following defectives:

1. It is not so handy as it is inflated by press and prevented from directly blow by mouth;

2. It is composed of too many elements and multiple courses of adhesion is required resulting in complicate assembly process, longer work hours and higher production cost.

3. As the check member (152) of the air release valve (15) protrudes out of the air bag (16), any accidental press in the course of use could easily cause air leak; and

4. The elasticity design of the check member (142 or 152) of the air delivery valve (14) or the air release valve (15) must be first overcome before delivering or releasing the air. Once the elasticity gets too large, the air delivery or release becomes difficult; on the contrary, the smaller elasticity fails to achieve the purpose of air tightness.

### SUMMARY OF THE INVENTION

The primary purpose of the present invention is to provide an air bag inflation device that allows the air bag to be inflated directly by blowing into the air bag by mouth.

Another purpose of the present invention is to provide an air bag inflation device that requires minim number of elements and course of adhesion to allow easy assembly, short work hours and lower production cost.

Another purpose yet of the present invention is to provide an air bag inflation device that permits inflation by press or by blow with mouth for better practicability.

Another purpose yet of the present invention is to provide an air bag inflation device with an arc press member for air release to be built in and flush with the end surface of the main portion of the device to avoid accidental air release.

Another purpose yet of the present invention is to provide an air bag inflation device with its check valve provided with a closing diaphragm at its head and allowed a proper space for placement when mounted to the main portion so to facilitate air inlet and air release without compromising the airtight efficiency.

### BRIEF DESCRIPTION OF THE DRAWINGS

FIG. 1 is a perspective view of a prior art of the present invention;

FIG. 2 is a schematic view showing the inflation executed by the prior art inside an air bag;

FIG. 3 is another schematic view showing the inflation executed by the prior art inside the air bag;

FIG. 4 is a schematic view showing air release executed by the prior art in the air bag;

FIG. 5 is a perspective view of the present invention;

FIG. 5A is a perspective view of a main portion of the present invention placed in its reverse side;

FIG. 5B is a top view of the main portion of the present invention;

FIG. 6 is a perspective view of an assembly of the present invention;

FIG. 7 is a sectional view of the assembly of the present invention;

FIG. 8 is sectional view of the present invention applied in an air bag;

FIG. 9 is a schematic view showing the air bag is inflated by mouth blowing into the present invention;

FIG. 9A is a sectional view of the deflated air bag containing the present invention;

FIG. 10 is a schematic view showing air release executed by the present invention in the air bag;

FIG. 11 is a schematic view showing that the present invention is applied in a sports shoe;

FIG. 12 is a perspective view of another preferred embodiment of the present invention;

FIG. 12A is a perspective view of another preferred embodiment of the present invention in its reverse side;

FIG. 12B is a top view of a main portion of another preferred embodiment of the present invention;

FIG. 13 is a perspective view of an assembly of another preferred embodiment of the present invention;

FIG. 14 is a sectional view of the assembly of another preferred embodiment of the present invention;

FIG. 15 is a sectional view showing that another preferred embodiment is applied in an air bag;

FIG. 16 is a schematic view showing that the air bag containing another preferred embodiment of the present invention is pressed to inflate;

FIG. 17 is another schematic view showing that the air bag containing another preferred embodiment of the present invention is pressed to inflate;

FIG. 18 is a schematic view showing that the air in the air bag containing another preferred embodiment of the present invention is released;

FIG. 19 is a schematic view showing that the air bag containing another preferred embodiment of the present invention is inflated by mouth blowing.

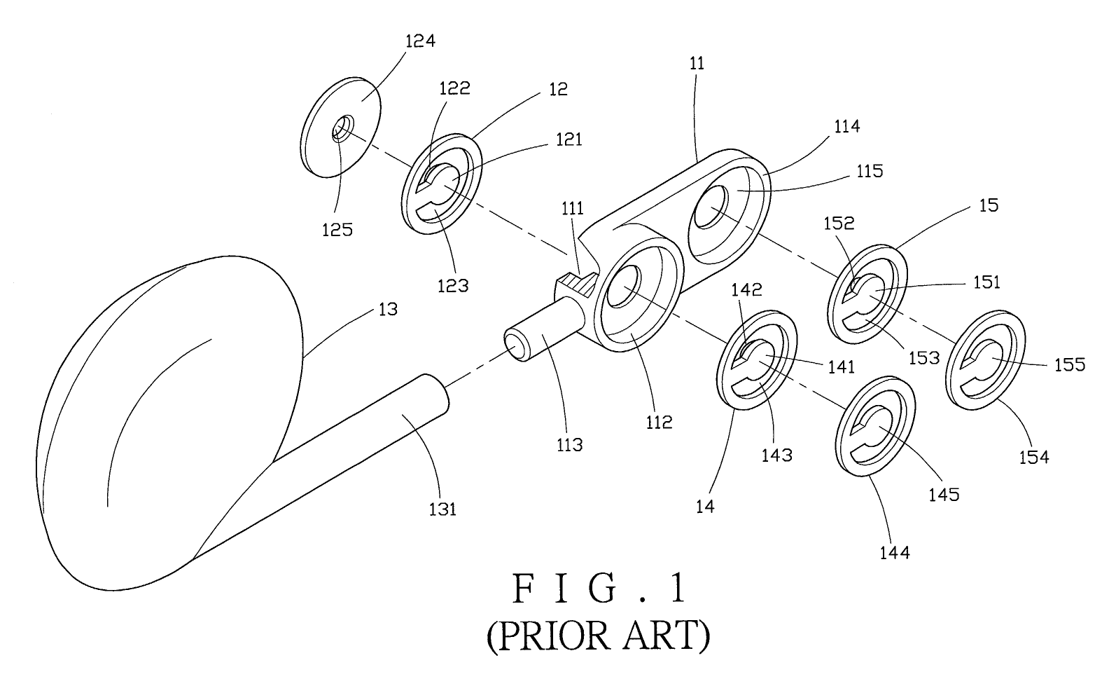

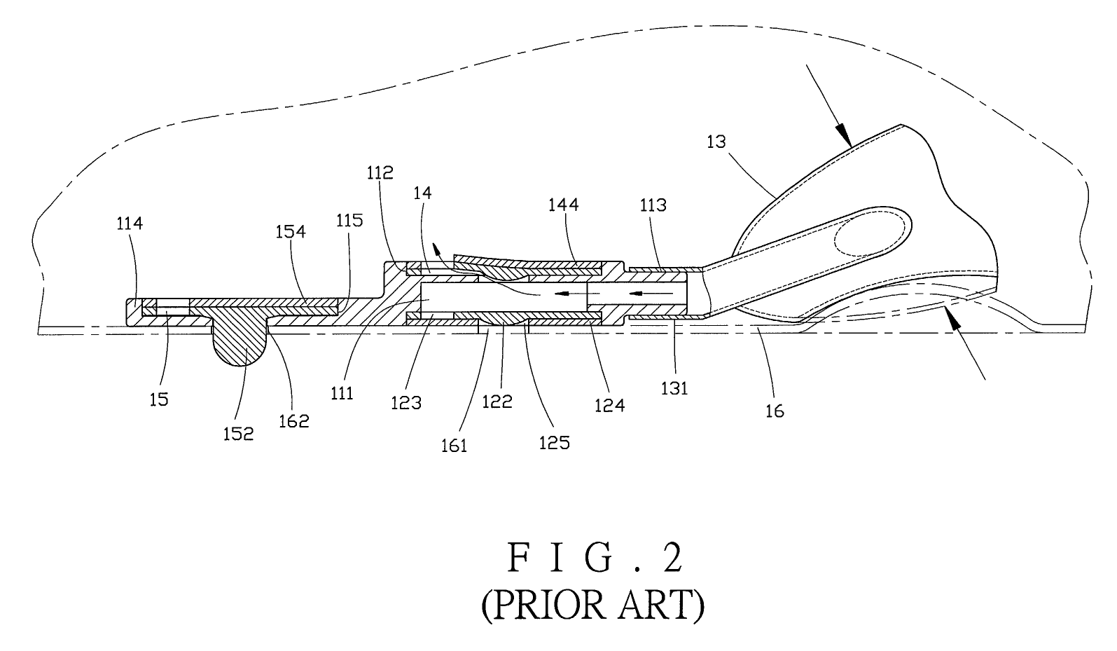

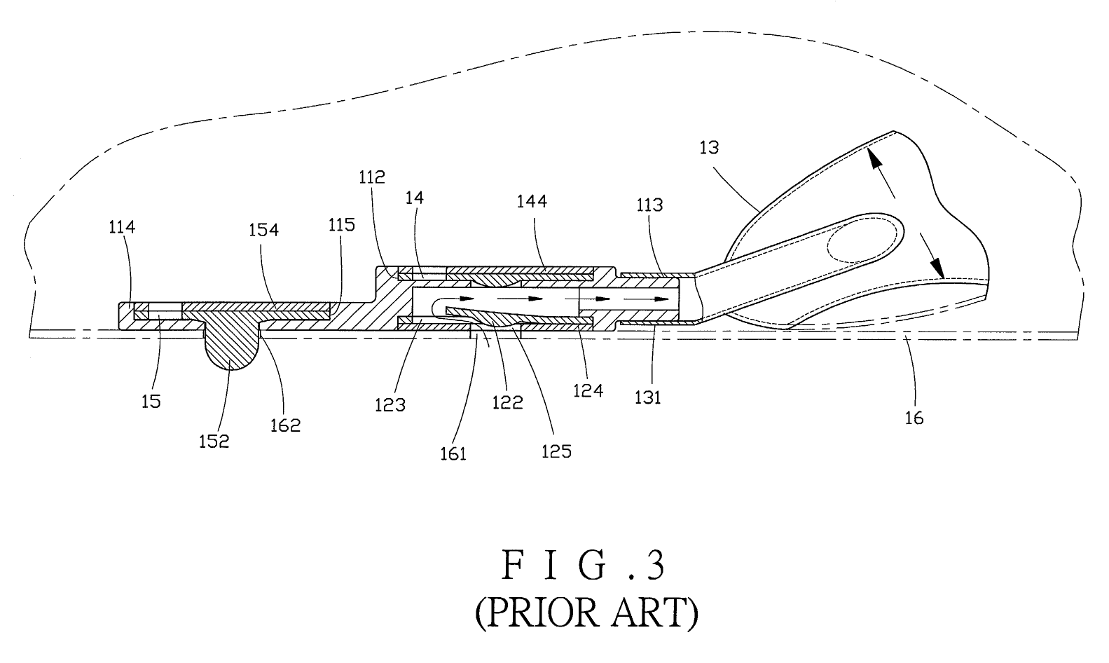

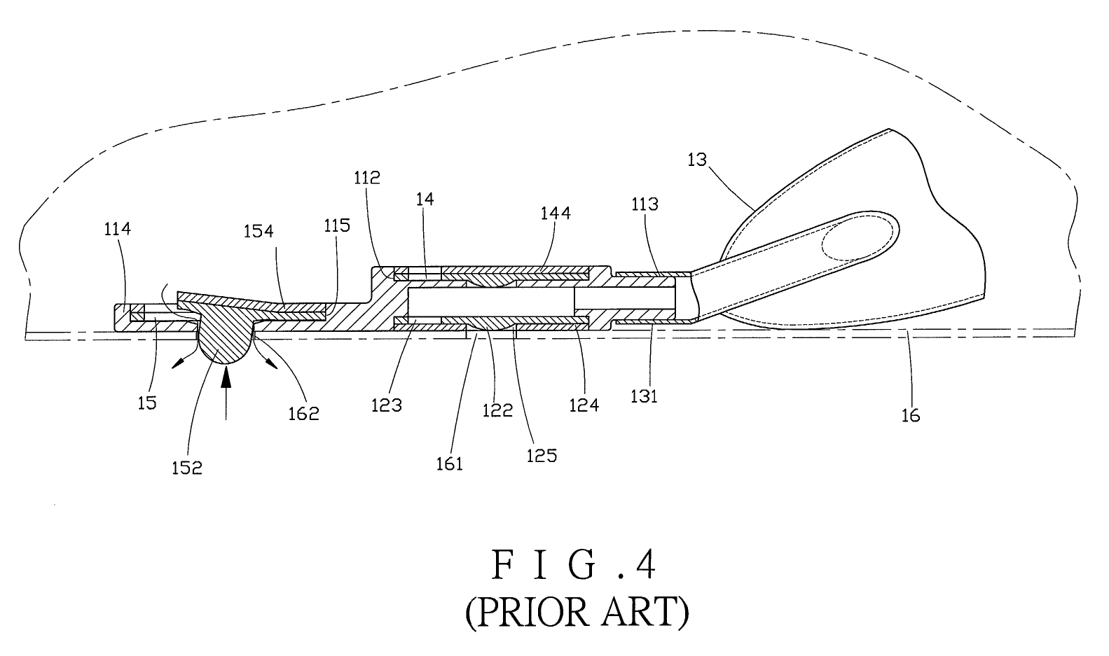

### DETAILED DESCRIPTION OF THE PREFERRED EMBODIMENTS

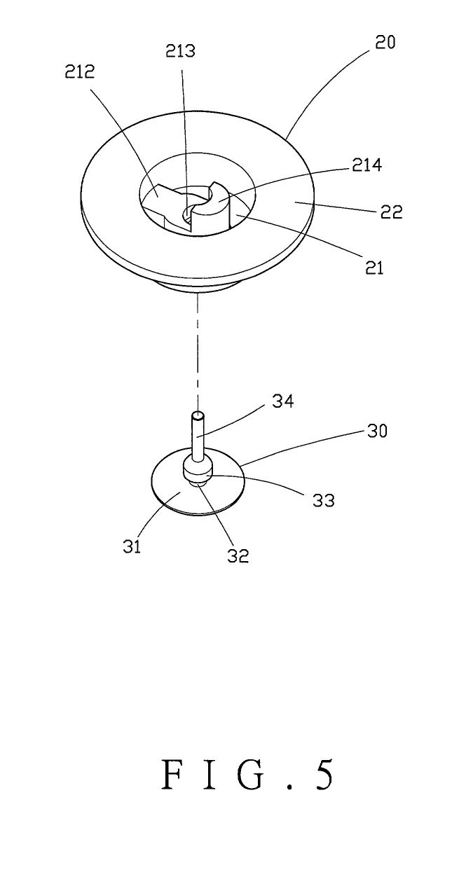

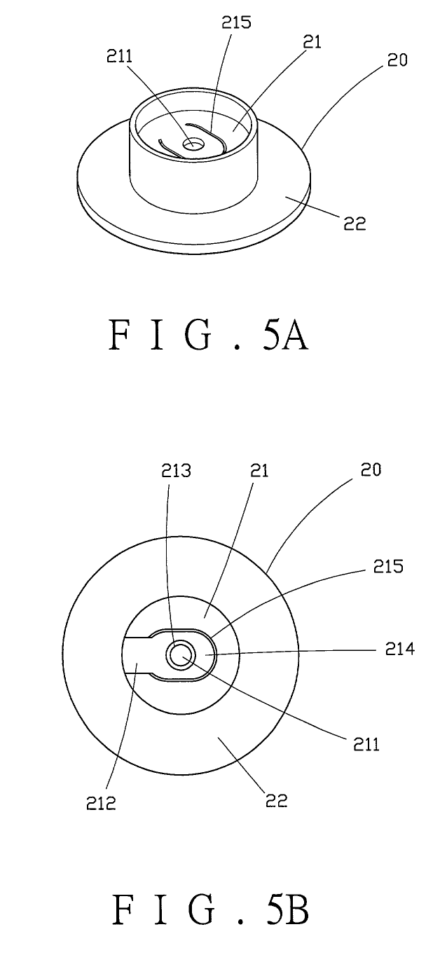

Referring to FIGS. 5, 5A and 5B, the present invention comprises a main portion (20) and a check valve (30).

The main portion (20) is a hollow case containing a partition (21) provided closer to one end inside the case. An insertion hole (211) is provided in the center of the partition (21) and a U-shaped air ventilation cut (215) is provided surrounding the insertion hole (211). A positioning bit (212) extends from the inner edge of the main portion (20) towards the U-shaped air ventilation cut (215). A circular groove (213) is provided on the positioning bit (212) in relation to the insertion hole (211). An arc press (214) is disposed at where between the insertion hole (211) and the ventilation cut (215) opposite to the positioning bit (212) for the positioning bit (21) to be depressed. A fixation ring (22) is provided to the main portion (20) for the main portion (20) to be easily fixed to an air bag (A) [to be described later].

A closing diaphragm (31) is provided at one end of the check valve (30). An insertion section (32) is provided at the center of the closing diaphragm (31) to be connected to a caulking section (33) having a conic terminal and in a larger diameter than that of the insertion section (32). The insertion section (32) is longer than the depth of the insertion hole (211) and the terminal of the caulking section (33) is further connected to an extension section (34).

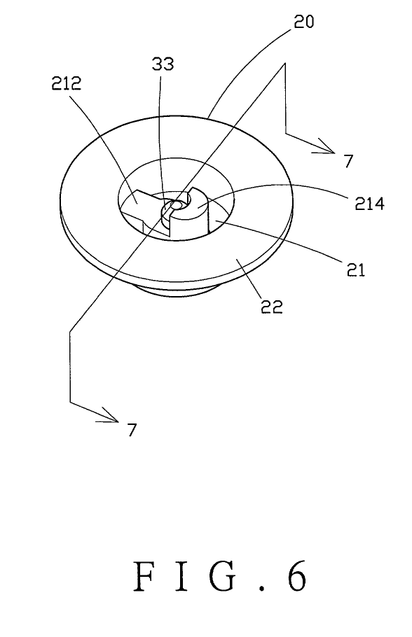

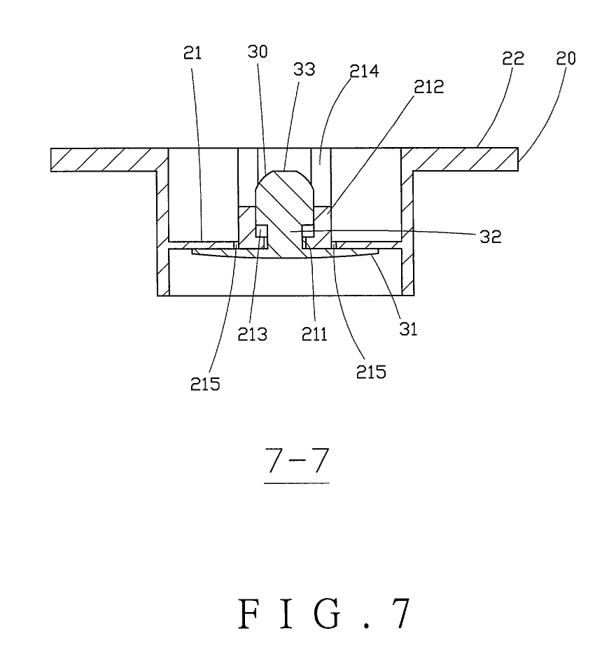

As illustrated in FIGS. 6 and 7, the extension section (34) of the check valve (30) is inserted through the insertion hole (211) and the circular groove (213) of the main portion (20). The extension section (34) is then properly pulled for the caulking section (33) of the check valve (30) to force passing by its conic terminal and its elasticity through the insertion hole (211) of the main portion (20) before being received in the circular groove (213) of the main portion (20). Meanwhile the insertion section (32) of the check valve (30) inserted through the insertion hole (211) of the main portion (20) is permitted to move. Finally, the extension section (34) is cut off to complete the assembly of the present invention.

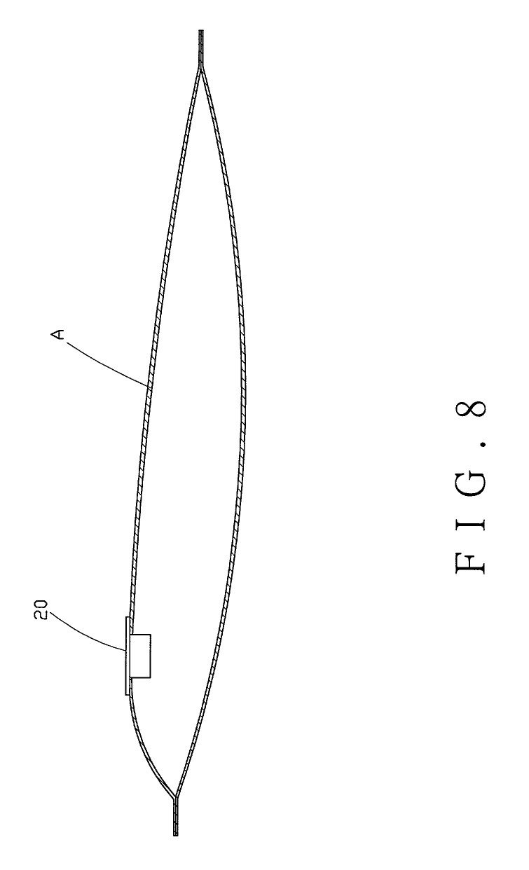

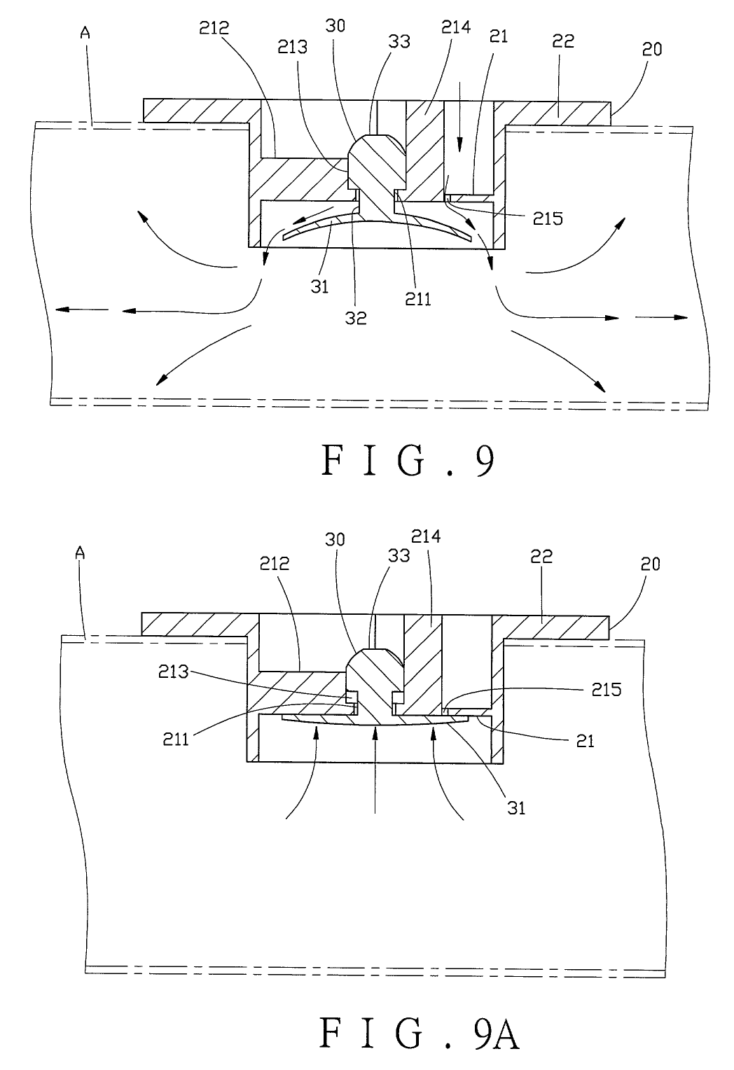

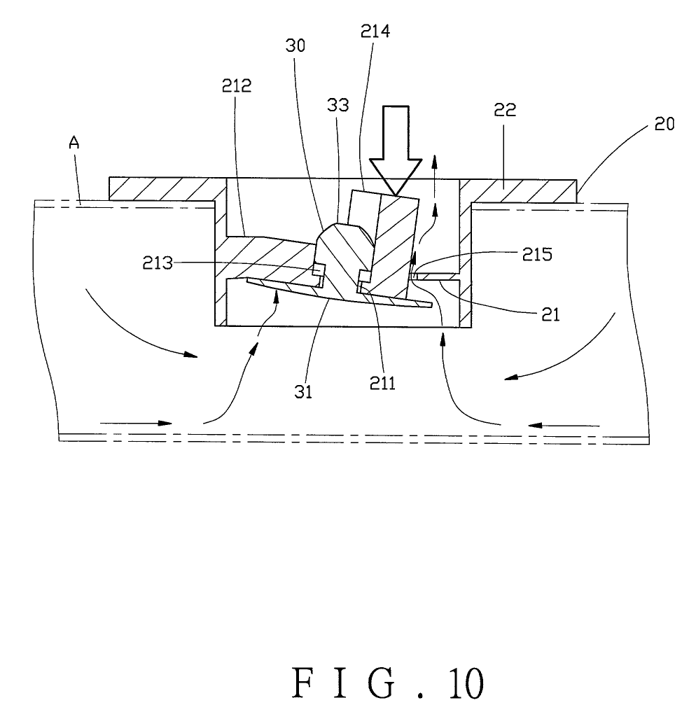

Now referring to FIGS. 8 and 9, the present invention is applied in an air bag that can be inflated by mouth blowing so that the inflation device of the present invention can be adhered to the outer edge of the air bag (A) by high frequency treatment [by means of the fixation ring (22)]. Then the air is mouth blowing into the main portion (20) [while blowing, the mouth may or may not directly contact the main portion (20) as elected]. The air then flows through the U-shaped air ventilation cut (215) of the main portion (20) to push through the closing diaphragm (31) and enters into and thus inflates the air bag (A). Once the air bag (A) is inflated, the air pressure inside the air bag (A) or that created when the external pressure is applied as illustrated in FIG. 9A pushes in opposite direction against the closing diaphragm (31) of the check valve (30) for the closing diaphragm (31) to hold against the U-shaped air ventilation cut (215) of the main portion (20) to become airtight. As illustrated in FIG. 10, to deflate the air inside the air bag (A), the arc press (214) of the main portion (20) is depressed for the positioning bit (21) to cause the check valve (30) to be inclined, thus to disengage the closing diaphragm (31) of the check valve (30) from the U-shaped air ventilation cut (215) of the main portion (20). Accordingly, the air in the air bag (A) is discharged out of the U-shaped air ventilation cut (215) of the main portion (20) to regulate the size of the air bag (A). Pressing the air bag (A) at the same time helps facilitate discharging the air inside the air bag (A).

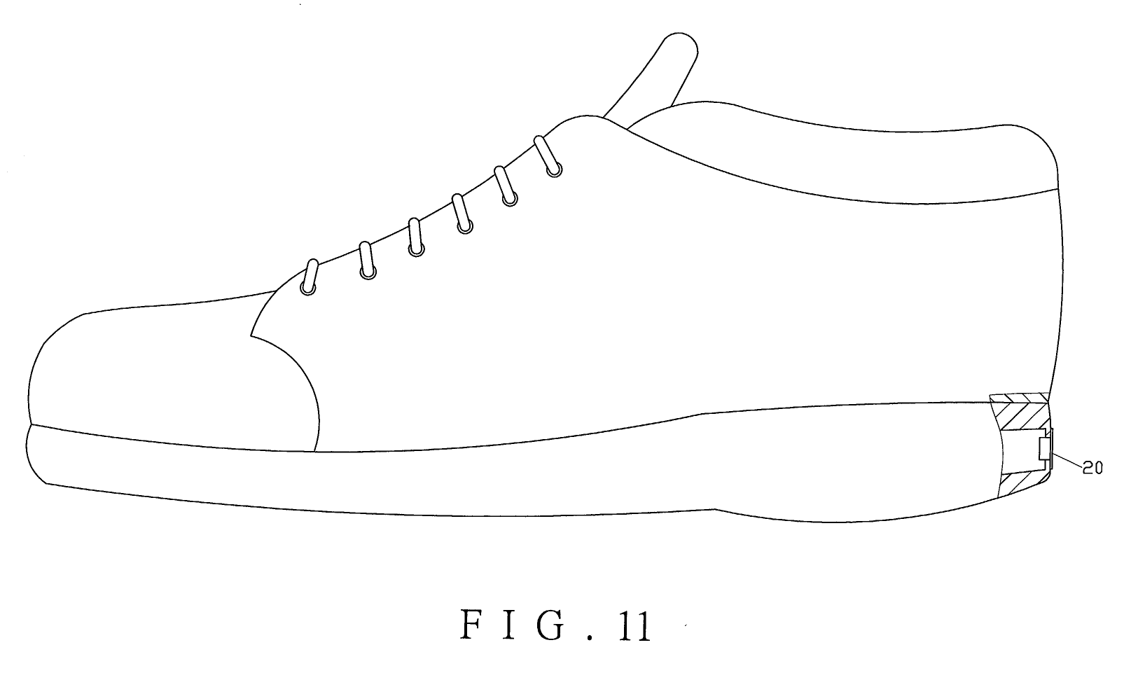

Furthermore, the inflation device of the present invention can be directly mounted into the middle sole of a sports show as illustrated in FIG. 11.

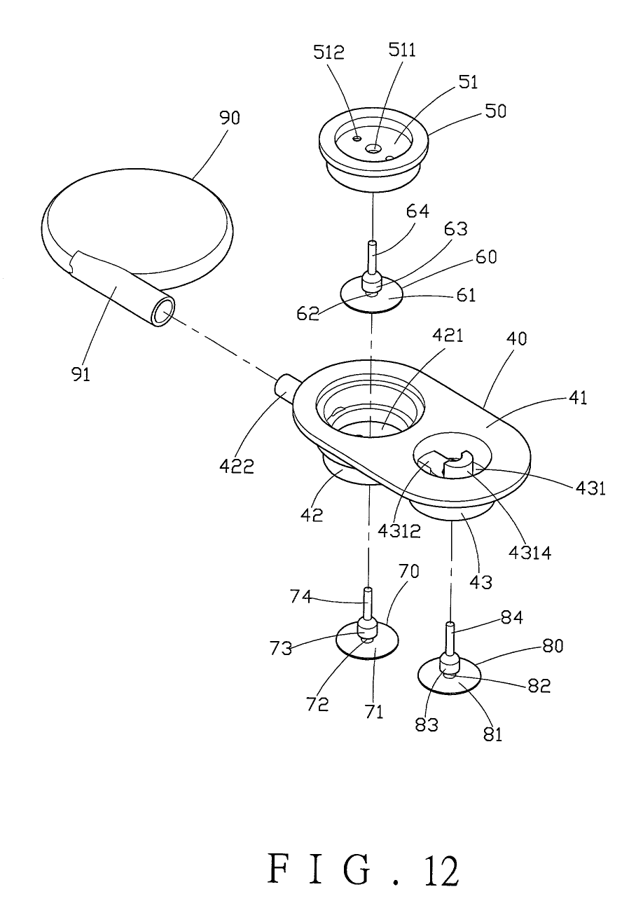

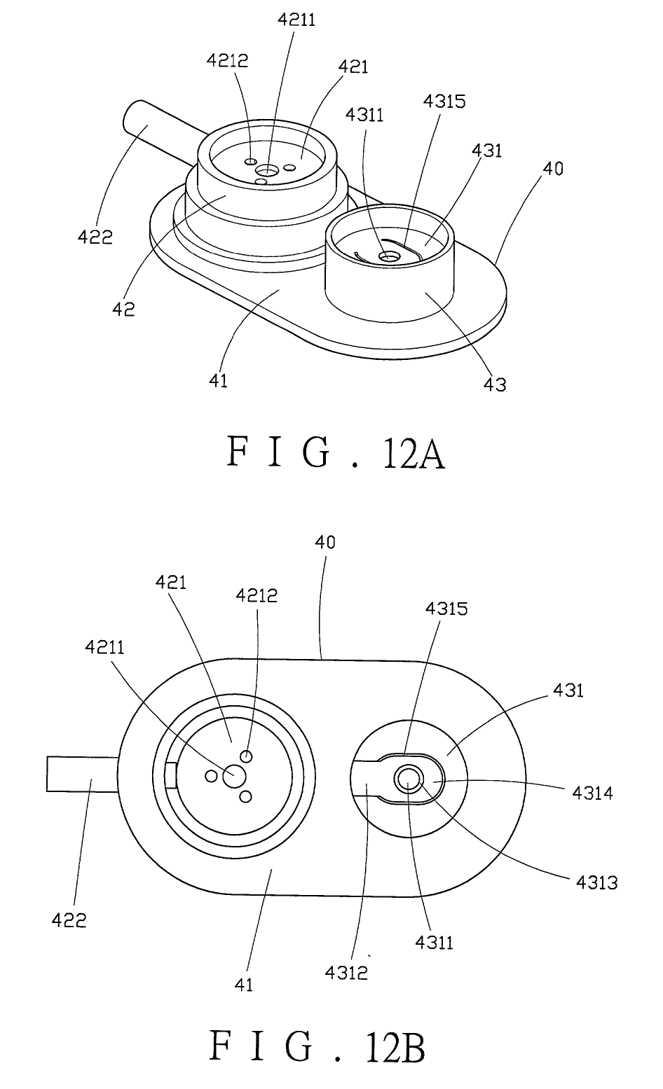

Now referring to FIGS. 12, 12A and 12B, another preferred embodiment of the present invention comprises a main portion (40), a cover (50), an air inlet (6), an air delivery valve (70), a check valve (80) and a pump (90). The main portion (40) provides an oval member (41) having a three-gradation sleeve (42) and a tubular sleeve (43) extending from one side of the oval member (41). A partition (421) is provided on the gradation having the smallest diameter of the three-gradation sleeve (42). An insertion hole (4211) is provided in the center of the partition (421) and three ventilation ports (4212) are provided surrounding the insertion hole (4211). An air pipe (422) extends from one side edge of the three-gradation sleeve (42). Another partition (431) having a center hole (4311) is provided at where closer to one end inside the tubular sleeve (43). A positioning bit (4312) extends from the inner edge of the tubular sleeve (43) towards the center and a circular groove (4313) connecting through the insertion hole (4311) is provided to the positioning bit (4312) in relation to the insertion hole (4311). An arc press (4314) extends outwardly from the periphery of the circular groove (4313) at the end surface of the positioning bit (4312). A U-shaped air ventilation cut (4315) is provided to the partition (431) around the front periphery of the positioning bit (4312) which is made to be depressed. The cover (50) is a hollow tube containing a partition (51) provided at where closer to one end and an insertion hole (511) is provided in the center of the partition (51). Two ventilation ports (512) are provided surrounding the insertion hole (511). A closing diaphragm (61) is provided at one end of the air inlet valve (60) and an insertion section (62) is provided on the closing diaphragm (61). The insertion section (62) is connected to a caulking section (63) having a conic terminal and in a diameter larger than that of the insertion section (62). The insertion section (62) is longer than that of the insertion hole (511) of the cover (50). An extension section (64) is further connected to the terminal of the caulking section (63). A closing diaphragm (71) is provided at one end of the air delivery valve (70) and an insertion section (72) provided on the closing diaphragm (71) is connected to a caulking section (73) having a conic terminal and in a diameter larger than that of the insertion section (72). The length of the insertion section (72) is longer than the depth of the insertion hole (4211) of the main portion (40). An extension section (74) is connected to the terminal of the caulking section (73). A closing diaphragm (81) is provided at one end of the check valve (80) and an insertion section (82) provided on the closing diaphragm (81) is connected to a caulking section (83) having a conic terminal and in a diameter larger than that of the insertion section (82). The length of the insertion section (82) is greater than that of the insertion hole (4311) of the main portion (40). An extension section (84) is connected to the terminal of the caulking section (83). The pump (90) is a flexible hollow member that can be automatically restored to its original status and a sleeve (91) extends from one side of the pump (90).

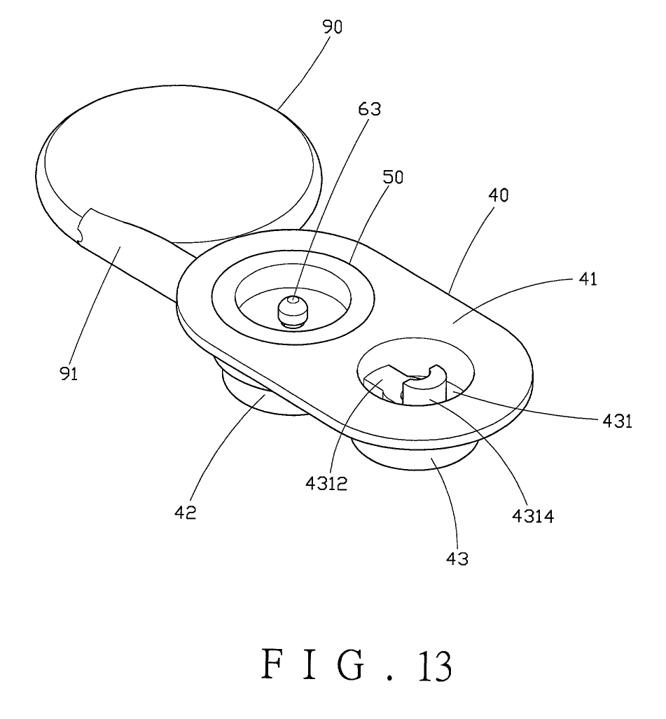

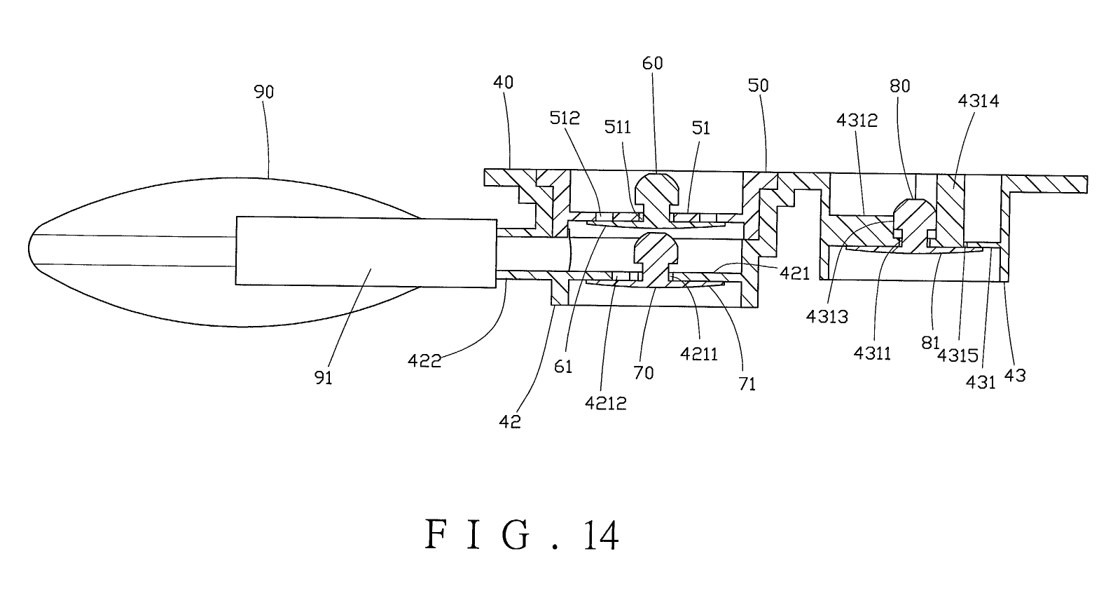

As illustrated in FIGS. 13 and 14, the extension section (74) of the air delivery valve (70) is inserted through the insertion hole (4211) in the partition (421) of the main portion (40). The extension section (74) is properly pulled for the caulking section (73) of the air delivery valve (74) by means of its conic terminal and its elasticity to force passing through the insertion hole (4211) in the partition (421). Meanwhile, the insertion section (72) of the air delivery valve (70) inserted through the insertion hole (4211) in the partition (421) is free to move. Then the extension section (74) is cut off. The extension section (64) of the air inlet valve (60) is inserted through the insertion hole (511) in the partition (51) of the cover (50). The extension section (64) is properly pulled to allow the caulking section (63) of the air inlet valve (60) by means of its conic terminal and its elasticity to force passing through the insertion hole (511) in the partition (51). Meanwhile, the insertion section (62) of the air inlet valve (60) inserted through the insertion hole (511) in the partition (50) is free to move. Then the extension section (64) is cut off and the cover (50) is adhered to the gradations of the largest and the second largest diameters in the three-gradation sleeve (42) of the main portion (40). The extension section (84) of the check valve (80) is inserted through the insertion hole (4311) and the circular groove (4313) of the partition (431) of the main portion (40). Again, the extension section (84) is properly pulled for the caulking section (83) from the check valve (80) by means of its conic terminal and its elasticity to force passing the insertion hole (4311) in the partition (431) before being received in the circular groove (4313) of the partition (431). Meanwhile, the insertion section (82) from the check valve (80) inserted through the insertion hole (4311) in the partition (431) is free to move. Then the extension section (84) is cut off. The sleeve (91) of the pump (90) is connected to the air pipe (422) of the main portion (40) to complete the assembly.

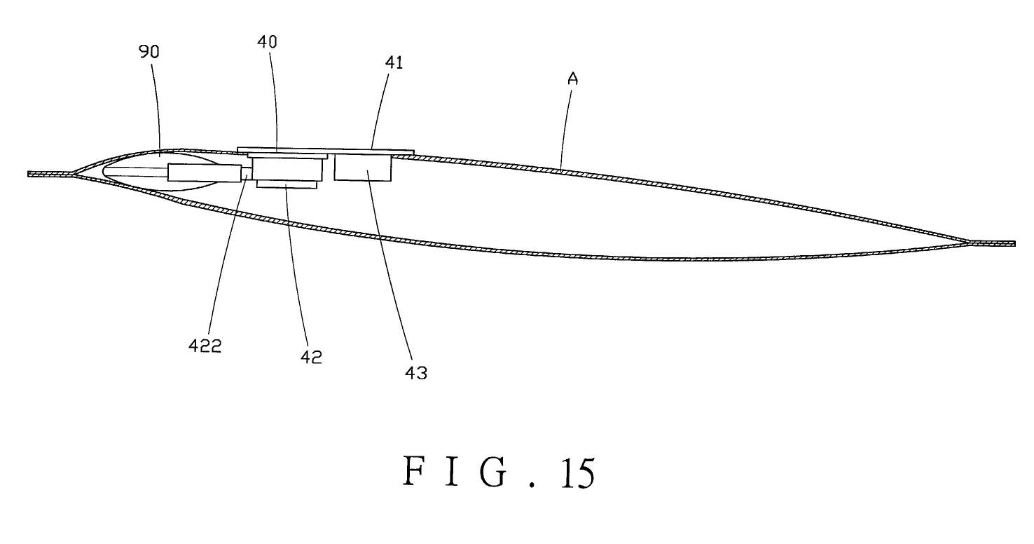

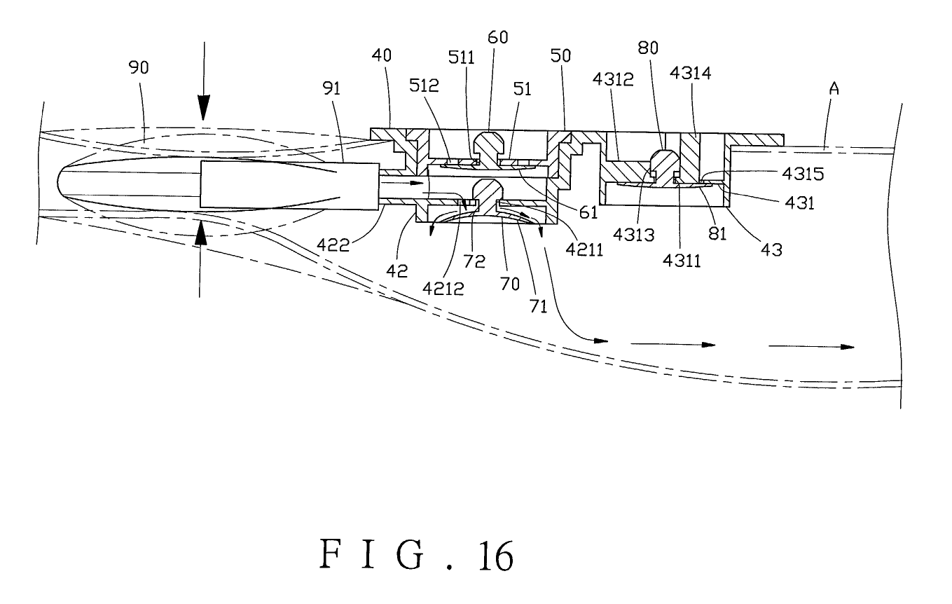

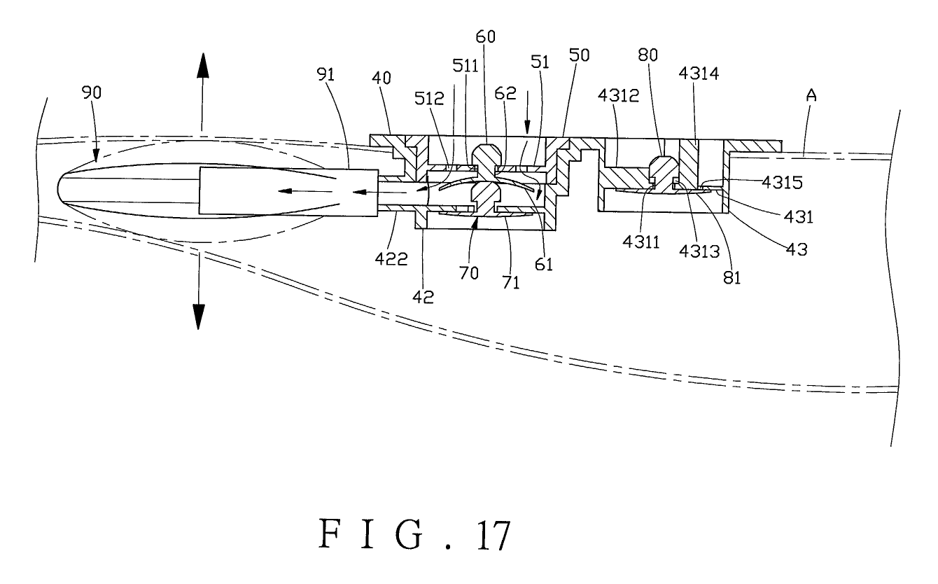

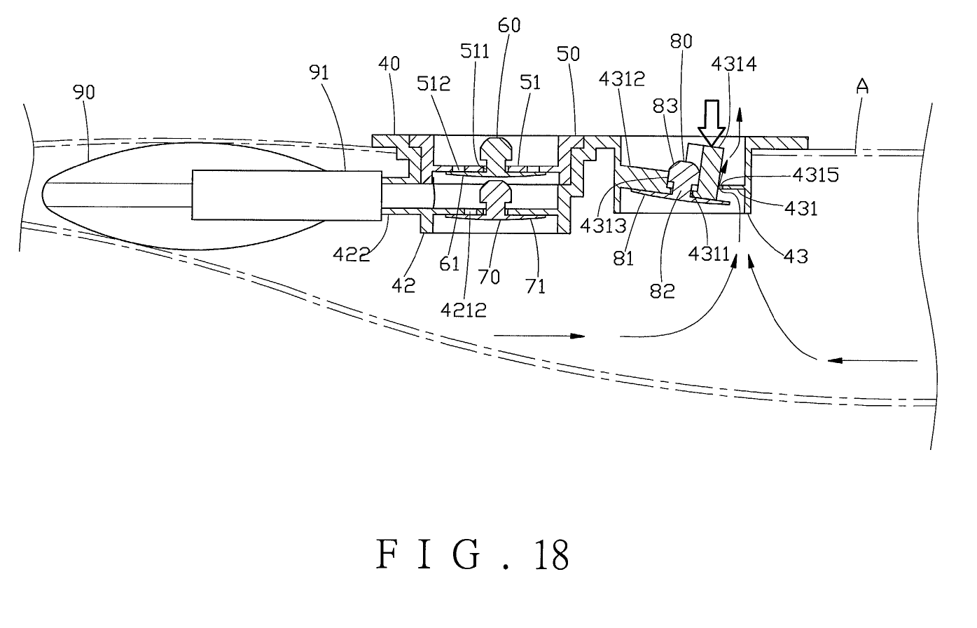

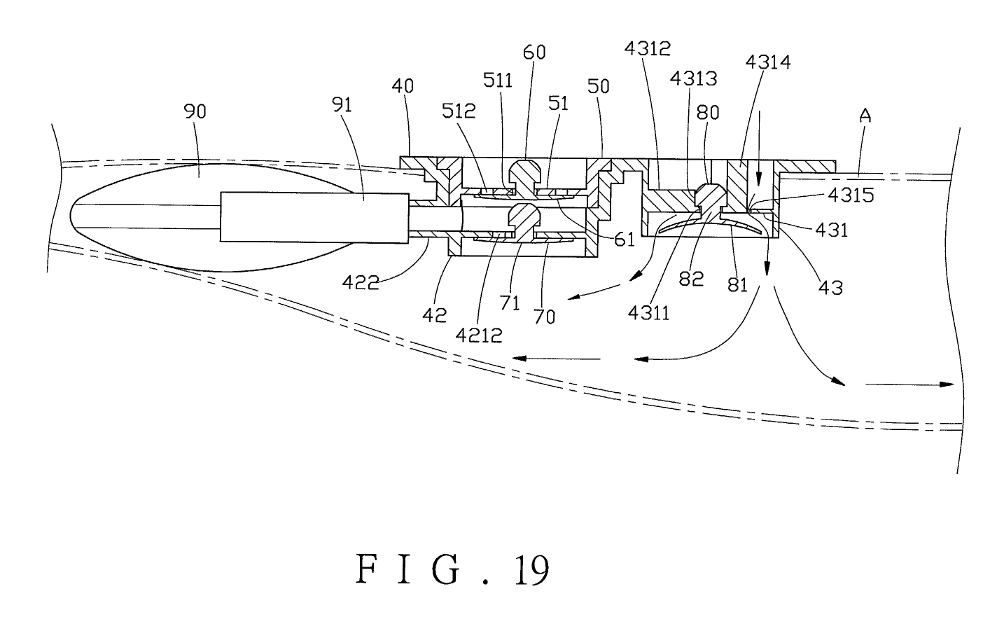

As illustrated in FIGS. 15 and 16, inflation of the air bag (A) by press is executed by the present invention. Wherein, the inflation device of the present invention is adhered to outer edge of the air bag (A) by high frequency treatment so to allow the pump (90) to be pressed by manual. Accordingly, the air in the pump (90) forces the closing diaphragm (61) of the air inlet valve (60) to close up the ventilation port (512) of the cover (50) and on the other hand pushes away the closing diaphragm (71) of the air delivery valve (7) through the ventilation port of the partition (421) to forthwith flow into and inflate the air bag (A). The air in the air bag (A) compresses the air release valve (80) for the closing diaphragm (81) of the air release valve (80) to close up the U-shaped ventilation port (4315) in the partition (431). When the pump (90) is released, as also illustrated in FIG. 17 for an air bag to be pressed for inflation by another preferred embodiment), the pump (90) by the restoration of the material produces a suction of negative pressure, thus to cause the closing diaphragm (71) of the air delivery valve (70) to close up the ventilation port (4212) in the partition (421), and to open up the air inlet valve (60). Accordingly, the air outside the air bag (A) flows through the ventilation port (512) of the partition (51), the three-gradation sleeve (42) and the air pipe (422) of the main portion (40), and finally into the pump (90) until the pump (90) restores to its original shape. Meanwhile, air pressure in the air bag (A) is sufficient to cause both of the closing diaphragm (71) of the air delivery valve (70) and the closing diaphragm (81) of the check valve (80) to close up the ventilation ports (4212, 4315) respectively provided in partitions (421, 431). As illustrated in FIG. 18, air release is executed by another preferred embodiment of the present invention. Wherein, the arc press (4314) of the main portion (40) is depressed for the positioning bit (4312) to cause the check valve (80) to incline, thus to disengage the closing diaphragm (81) of the check valve (80) from the U-shaped ventilation cut (4315) in the partition (431). Accordingly, air in the air bag (A) is discharged from said U-shaped ventilation cut (4315) so to regulate the size of the air bag (A). Meanwhile, pressing the air bag (A) at the same time helps speed up the discharging of the air from the air bag (A). Furthermore, also as illustrated in FIG. 19 showing inflation by mouth blowing, upon inflating the air bag (A), blow the air by mouth aiming at the tubular sleeve (43) of the main portion (40) (while blowing, the mouth may or may not directly contact the main portion (40) as elected). The air then pushes through the closing diaphragm from the U-shaped ventilation port (4315) of the main portion (40) to enter into and inflate the air bag (A).

By means of the preferred embodiments described above, the present invention offers the following benefits:

1. It is more convenient in use since the inflation can be done by directly blowing the air with mouth.

2. It requires fewer elements, fewer courses of adhesion, easier assembly, shorter work hours and less production cost.

3. It is more practical since the inflation can be done by pressing and by mouth blowing at the same time.

4. It is leakage free since the arc press (213, 4314) for air release are concealed in the main portion (20, 40) and flush with the end surface of the main portion (20, 40).

5. It ensures of airtight effects due to easy and well-facilitated air inlet and air release.

I claim,

1. An air bag inflation device comprising a main portion and a check valve; wherein, said main portion in tubular shape containing a partition provided with an insertion hole; a U-shaped air ventilation cut being provided surrounding the insertion hole; a positioning bit extending from an inner edge of said main portion at the opening of the U-shaped cut; a circular groove connecting through said insertion hole being provided at said positioning bit in relation to said insertion hole; and a press being disposed at where between said insertion hole and said ventilation cut opposite to said positioning bit;
said check valve having provided with a closing diaphragm at one end, an insertion section provided on one side of said closing diaphragm; said insertion section connected to a caulking section; said caulking section having a conic terminal and in a diameter larger than that of said insertion section; and an extension section being connected to a terminal of said caulking section;
said check valve being inserted through said insertion hole in said main portion with said insertion section and said caulking section to cause said closing diaphragm to cover up said air ventilation port.

2. An air bag inflation device as claimed in claim 1, wherein, the length of said insertion section is greater than the depth of said insertion hole in said main portion.

3. An air bag inflation device as claimed in claim 1, comprising a cover, an air inlet valve, an air delivery valve, a check valve and a pump; wherein, said pump being a flexible hollow member that can be automatically restored to its original status; a sleeve being extended from one side of said pump; said main portion containing a plate with its one side extending for a multiple-gradation hollow sleeve and a straight tubular sleeve; an air pipe extending outwardly from one side edge of said multiple-gradation sleeve; a partition being provided on an inner edge of a gradation in the least diameter in the multiple-gradation sleeve; a central hole being provided in said partition; multiple air ventilation ports being provided surrounding said central hole of said partition; another partition having a central hole being provided inside said straight tubular sleeve at where closer to either end; a positioning bit extending from an inner edge of said straight tubular sleeve towards its center; a circular groove connecting through said central hole being provided to said positioning bit in relation to said insertion hole; a press extending outwardly from the periphery of said circular groove at the end surface of said positioning bit; a U-shaped air ventilation cut being provided to said partition in the front semi-periphery of said positioning bit; and said positioning bit being made to be depressed;
said cover, a hollow tubular body, containing a partition at where closer to either end; an insertion hole being provided in the center of said partition and multiple air ventilation ports being provided surrounding said insertion hole;
said air inlet valve, said air delivery valve and said check valve being each provided a closing diaphragm at one end; an insertion section provided on one side of said closing diaphragm; said insertion section connected to a caulking section; said caulking section having a conic terminal and in a diameter larger than that of said insertion section; and an extension section being connected to the terminal of said caulking section;
said air delivery valve with its extension section and caulking section being inserted through said insertion hole of said main portion; said air inlet valve with its extension section and caulking section being inserted through said insertion hole of said cover; said cover being adhered to the gradations of the largest and the second largest diameters in said multiple-gradation sleeve of said main portion; said check valve with its extension section and caulking section being inserted through said insertion hole in said partition of said straight tubular sleeve.
